(19) United States
(12) Patent Application Publication
(10) Pub. No.: US 2008/0264182 A1
(43) Pub. Date: Oct. 30, 2008

(54) FLOW METER USING SENSITIVE DIFFERENTIAL PRESSURE MEASUREMENT

(76) Inventors: Richard T. Jones, Sanford, FL (US); Matthew J. Patterson, Glastonbury, CT (US)

Correspondence Address: PATTERSON & SHERIDAN, L.L.P., 3040 POST OAK BOULEVARD, SUITE 1500, HOUSTON, TX, 77056, US

(21) Appl. No.: 12/169,885

(22) Filed: Jul. 9, 2008

Related U.S. Application Data
(63) Continuation-in-part of application No. 12/017,934, filed on Jan. 22, 2008.
Application No. 12/017,934 is a continuation of application No. 11/532,995, filed on Sep. 19, 2006, now Pat. No. 7,320,252.
Application No. 11/532,995 is a continuation of application No. 11/168,819, filed on Jun. 28, 2005, now Pat. No. 7,107,860.
Application No. 11/168,819 is a continuation of application No. 10/647,014, filed on Aug. 22, 2003, now Pat. No. 6,910,388.

(51) Int. Cl. G01F 1/44

(52) U.S. Cl. 73/861.63

(57) ABSTRACT

Methods and apparatus for measuring the flow rate of a fluid within tubing utilize probes to measure a differential pressure of the fluid along a section of the tubing. Various calculations utilize this pressure differential to determine the flow rate of the fluid. For example, determining the flow rate for the fluid may include calculating the flow rate utilizing the differential pressure measured within an equation related to at least one of friction loss through the tubing, elevation head loss through the tubing, and/or head loss through the tubing due to a change in direction of fluid flow through the tubing.

### CROSS-REFERENCE TO RELATED APPLICATIONS

This application is a continuation-in-part of U.S. patent application Ser. No. 12/017,934 filed Jan. 22, 2008, which is a continuation of U.S. patent application Ser. No. 11/532,995 filed Sep. 19, 2006, now U.S. Pat. No. 7,320,252, which is a continuation of U.S. patent application Ser. No. 11/168,819 filed Jun. 28, 2005, now U.S. Pat. No. 7,107,860, which is a continuation of U.S. patent application Ser. No. 10/647,014 filed Aug. 22, 2003, now U.S. Pat. No. 6,910,388. The aforementioned related patent applications are herein incorporated by reference.

### BACKGROUND OF THE INVENTION

1. Field of the Invention

Embodiments of the present invention generally relate to measuring flow rates.

2. Description of the Related Art

In the drilling of oil and gas wells, a wellbore is formed using a drill bit that is urged downwardly at a lower end of a drill string. When the well is drilled to a first designated depth, a first string of casing is run into the wellbore. The first string of casing is hung from the surface, and then cement is circulated into the annulus behind the casing. Typically, the well is drilled to a second designated depth after the first string of casing is set in the wellbore. A second string of casing, or liner, is run into the wellbore to the second designated depth. This process may be repeated with additional liner strings until the well has been drilled to total depth. In this manner, wells are typically formed with two or more strings of casing having an ever-decreasing diameter.

After a well has been drilled, it is desirable to provide a flow path for hydrocarbons from the surrounding formation into the newly formed wellbore to allow for hydrocarbon production. Therefore, after all of the casing has been set, perforations are shot through a wall of the liner string at a depth which equates to the anticipated depth of hydrocarbons. Alternatively, a liner having pre-formed slots may be run into the hole as casing. Alternatively still, a lower portion of the wellbore may remain uncased so that the formation and fluids residing therein remain exposed to the wellbore.

During the life of a producing hydrocarbon well, real-time, downhole flow data regarding the flow rate of the hydrocarbons from the formation is of significant value for production optimization. The flow rate information is especially useful in allocating production from individual production zones, as well as identifying which portions of the well are contributing to hydrocarbon flow. Flow rate data may also prove useful in locating a problem area within the well during production. Real-time flow data conducted during production of hydrocarbons within a well allows determination of flow characteristics of the hydrocarbons without need for intervention. Furthermore, real-time downhole flow data may reduce the need for surface well tests and associated equipment, such as a surface test separator, thereby reducing production costs.

Downhole flow rate data is often gathered by use of a Venturi meter. The Venturi meter is used to measure differential pressure of the hydrocarbon fluid across a constricted cross-sectional area portion of the Venturi meter, then the differential pressure is correlated with a known density of the hydrocarbon fluid to determine flow rate of the hydrocarbon mixture. FIG. 1 depicts a typical Venturi meter 9. The Venturi meter 9 is typically inserted into a production tubing string 8 at the point at which the flow rate data is desired to be obtained. Hydrocarbon fluid flow F exists through the production tubing string 8, which includes the Venturi meter 9, as shown in FIG. 1. The Venturi meter 9 has an inner diameter A at an end (point A), which is commensurate with the inner diameter of the production tubing string 8, then the inner diameter decreases at an angle X to an inner diameter B (at point B). Diameter B, the most constricted portion of the Venturi meter 9 typically termed the “throat”, is downstream according to fluid flow F from the end having diameter A. The Venturi meter 9 then increases in inner diameter downstream from diameter B as the inner diameter increases at angle Y to an inner diameter C (typically approximately equal to A) again commensurate with the production tubing string 8 inner diameter at an opposite end of the Venturi meter 9.

Angle X, which typically ranges from 15-20 degrees, is usually greater than angle Y, which typically ranges from 5-7 degrees. In this way, the fluid F is accelerated by passage through the converging cone of angle X, then the fluid F is retarded in the cone increasing by the smaller angle Y. The pressure of the fluid F is measured at diameter A at the upstream end of the Venturi meter 9, and the pressure of the fluid F is also measured at diameter B of the throat of the Venturi meter 9, and the difference in pressures is used along with density to determine the flow rate of the hydrocarbon fluid F through the Venturi meter 9.

In conventional Venturi meters used in downhole applications, diameter A is larger than diameter B. Typically, diameter A is much larger than diameter B to ensure a large differential pressure between points A and B. This large differential pressure is often required because the equipment typically used to measure the difference in pressure between the fluid F at diameter A and the fluid F at diameter B is not sensitive enough to detect small differential pressures between fluid F flowing through diameter A and through diameter B. The extent of convergence of the inner diameter of the Venturi meter typically required to create a measurable differential pressure significantly reduces the available cross-sectional area through the production tubing string 8 at diameter B. Reducing the cross-sectional area of the production tubing string 8 to any extent to obtain differential pressure measurements is disadvantageous because the available area through which hydrocarbons may be produced to the surface is reduced, thus affecting production rates and, consequently, reducing profitability of the hydrocarbon well. Furthermore, reducing the cross-sectional area of the production tubing string with the currently used Venturi meter limits the outer diameter of downhole tools which may be utilized during production and/or intervention operations during the life of the well, possibly preventing the use of a necessary or desired downhole tool.

Venturi flow meters suffer from additional disadvantages to restricted access below the device (which may prevent the running of tools below the device) and reduced hydrocarbon flow rate. Venturi meters currently used cause significant pressure loss due to the restrictive nature of the devices. Further, because these devices restrict flow of the mixture within the tubing string, loss of calibration is likely due to erosion and/or accumulation of deposits (e.g., of wax, asphaltenes, etc.). These disadvantages may be compounded by poor resolution and accuracy of pressure sensors used to measure the pressure differences. Overcoming the poor resolution and accuracy may require the use of high contraction ratio (e.g., more restrictive) Venturi meters, thus further disadvantageously restricting the available cross-sectional area for hydrocarbon fluid flow and lowering downhole tools.

Therefore, there exists a need for a flow meter that does not require a change in inner diameter of production or other tubing through which fluid flows.

### SUMMARY OF THE INVENTION

In one embodiment, a method determines a flow rate of fluid flowing within a pipe when a differential pressure is created in the fluid flowing through the pipe without introducing a constriction defining a discrete minimum interior cross-sectional area of the pipe in order to create the differential pressure. Measuring the differential pressure between two locations along the pipe achieves a differential pressure resolution of 0.001 pounds per square inch, differential. The method further includes determining the flow rate for the fluid based on the differential pressure measured.

For one embodiment, a method determines a flow rate of fluid flowing within a pipe when a differential pressure is created in the fluid flowing through a section of the pipe with an interior cross-sectional area that remains substantially constant. Measuring the differential pressure between two locations along the section of the pipe achieves a differential pressure resolution of 0.001 pounds per square inch, differential. In addition, the method includes determining the flow rate for the fluid based on the differential pressure measured.

According to one embodiment, a system for measuring a flow rate of a fluid includes a pipe for containing the fluid. In addition, pressure probes, which have a differential pressure resolution of 0.001 pounds per square inch, differential, measure between two locations a differential pressure that is created when the fluid flows through a section of the pipe with an interior cross-sectional area that remains substantially constant. Processing equipment of the system converts the differential pressure to flow rate data based on the differential pressure measured with the pressure probes.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a sectional view of a typical downhole Venturi meter inserted within a string of production tubing.

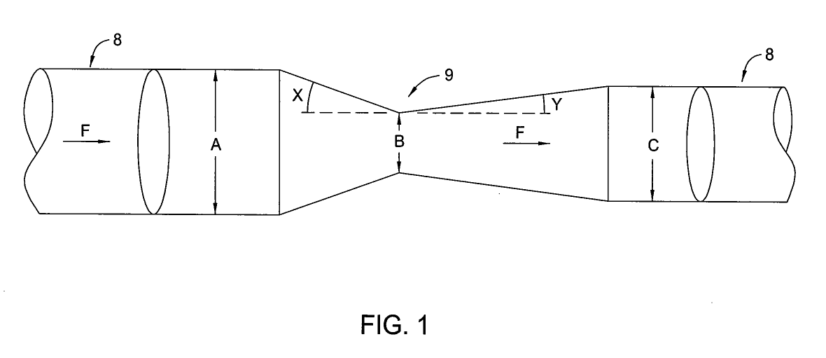

FIG. 2 is a sectional view of an exemplary flow rate measurement system including a flow meter according to an embodiment of the present invention. A differential pressure sensor measures pressure across the flow meter.

FIG. 3 is a sectional view of an alternate embodiment of the flow rate measurement system of the present invention. Two absolute pressure sensors measure pressure at two locations across the flow meter.

FIG. 4 is a sectional view of an alternate embodiment of the flow rate measurement system of the present invention. A fiber optic differential pressure sensor measures pressure across a flow meter according to the present invention.

FIG. 5 is a sectional view of a flow rate measurement system with pressure differential determined along a section of tubing where a diametrical cross-sectional area of the tubing remains substantially constant, according to embodiments of the invention.

FIG. 6 is a sectional view of a flow rate measurement system with pressure differential determined along a section of tubing that includes a bend, according to embodiments of the invention.

### DETAILED DESCRIPTION

By utilizing an ultra-sensitive differential pressure measurement device, embodiments of the invention allow flow rate measurements to be obtained without restricting an inner diameter of tubing. Various calculations utilize this pressure differential to determine the flow rate of the fluid. For example, determining the flow rate for the fluid may include calculating the flow rate utilizing the differential pressure measured within an equation related to at least one of friction loss through the tubing, elevation head loss through the tubing, and/or head loss through the tubing due to a change in direction of fluid flow through the tubing.

As used herein, the terms “tubing string” and “pipe” refer to any conduit for carrying fluid. Although the description below relates to a production tubing string, a tubing string utilized for any purpose, including intervention and completion operations, may employ the apparatus of the present invention to determine fluid flow rate. Fluid is defined as a liquid or a gas or a mixture of liquid or gas. To facilitate understanding, embodiments are described below in reference to measuring hydrocarbon fluid parameters, but it is contemplated that any fluid may be measured by the below-described apparatus and methods.

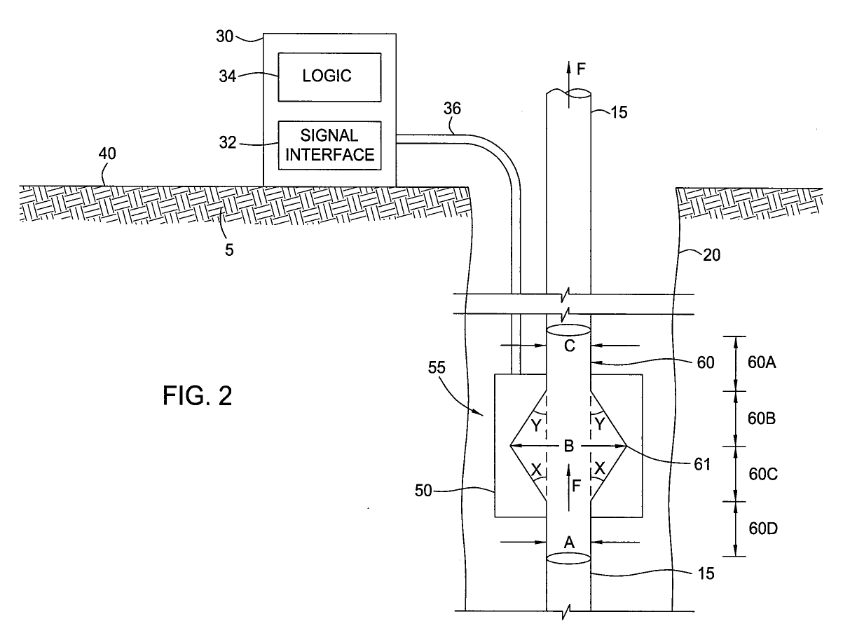

FIG. 2 shows an exemplary downhole flow rate measurement system 55 for obtaining measurements of flow rates of fluid F produced from a surrounding formation 5. (The flow rate measurement system 55 may also be used to measure the flow rates of other types of fluids flowing through a pipe for any purpose.) A flow meter (also “inverse Venturi meter”) 60 is disposed within a production tubing string 15, preferably threadedly connected at each end to a portion of the production tubing string 15, so that the inverse Venturi meter 60 is in fluid communication with the production tubing string 15. Fluid F flows from downhole within a production zone (not shown) in the formation 5 to a surface 40 of a wellbore 20, as indicated by the arrow shown in FIG. 2.

As shown in FIG. 2, the inverse Venturi meter 60 includes a tubular-shaped body with four portions 60A, 60B, 60C, and 60D. The lower portion 60D has a diameter A which is capable of mating with the portion of the tubing string 15 below the inverse Venturi meter 60. The lower middle portion 60C of the inverse Venturi meter 60, located above the lower portion 60D, gradually increases in diameter at a divergence angle X to a diameter B which exists at a throat 61 of the inverse Venturi meter 60. The throat 61 represents the maximum diameter B of the inverse Venturi meter 60. The diameter of the inverse Venturi meter 60 diverges outward from diameter A (the nominal pipe diameter) to the throat 61.

Now referring to the remaining portions 60A and 60B of the inverse Venturi meter 60, the upper portion 60A is of a diameter C which is capable of mating with the portion of the tubing string 15 above the inverse Venturi meter 60. Located below the upper portion 60A is the upper middle portion 60B. In the upper middle portion 60B, the diameter of the inverse Venturi meter 60 increases in diameter at a divergence angle Y until reaching the throat 61 at diameter B. In addition to representing the maximum diameter B of the Venturi meter 60, the throat 61 also is the point at which the upper middle portion 60B and the lower middle portion 60C meet.

The increase in diameter from diameter A and/or C to diameter B is minimal in comparison to the diameters A and C, in one embodiment most preferably an increase in diameter of approximately 0.25 inches. The goal is to maximize the available area within the production tubing 15 and the inverse Venturi meter 60 with respect to the inner diameter of the wellbore 20. Accordingly, taking into account the available diameter within the wellbore 20, an increase in diameter of the tubing string 15 at diameter B which is too large would unnecessarily restrict the inner diameter of the remainder of the tubing string 15 with respect to the size of the wellbore 20, decreasing hydrocarbon fluid flow and the area through which tools may be lowered into the production tubing 15. Exemplary, but not limiting, embodiments have a nominal diameter A and/or C of 3.5 inches, 4.5 inches, or 5.5 inches, with a throat 61 diameter B of 3.7, 4.7, or 5.6 inches, respectively, depending upon the diameter of the ends of the production tubing string 15 with which the inverse Venturi meter 60 is intended to mate. Most preferably, in an embodiment of the present invention, diameter A and/or C is about 3.5 inches, while diameter B is about 3.75 inches. Diameter A and diameter C may be the same or different diameters, depending upon the diameter of the ends of the production tubing string 15 with which the inverse Venturi meter 60 is intended to mate. Angles X and Y may be any angles which produce a measurable differential pressure between the throat 61 and diameter A. The angles X and Y and the lengths of the diverging sections 60B and 60C are determined such that a satisfactory Reynolds number is achieved in the flow range of interest. The angles X and Y shown in FIG. 2 are exaggerated for illustration purposes; ideally, although not limiting the range of angles contemplated, the angles are small to provide the maximum tubing string 15 diameter and diameters A and/or C through which tools may be inserted and through which fluid F may flow (taking into account the size of the wellbore 20).

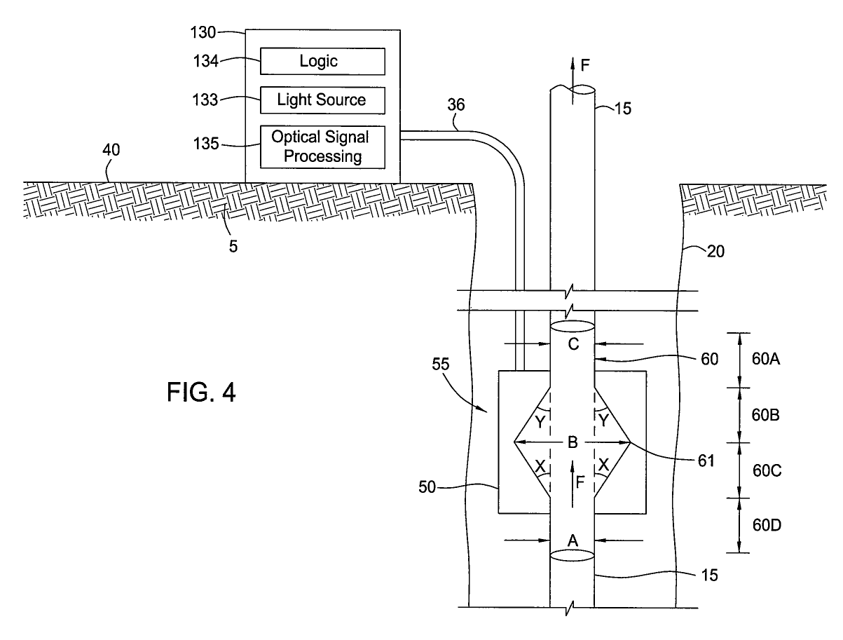

Disposed on the outer diameter of the inverse Venturi meter 60 and coupled to the pipe is a differential pressure sensor 50. The differential pressure sensor 50 has pressure ports leading to the throat 61 and to diameter A (or diameter C) so that it can detect the difference in pressure between diameter A (or diameter C) and the throat 61. The differential pressure sensor 50 may include any suitable high resolution or ultra-sensitive differential pressure sensor, including a fiber optic or optical differential pressure sensor (see FIG. 4). A suitable differential pressure sensor 50 is capable of measuring a difference in pressure between fluid F flowing through diameter A and fluid flowing through the throat 61.

Operatively connected to the differential pressure sensor 50 is at least one signal line or cable 36 or optical waveguides. The signal line 36 runs outside the tubing string 15 to the surface 40, where it connects at the opposite end to surface control circuitry 30. The control circuitry 30 may include any suitable circuitry responsive to signals generated by the differential pressure sensor 50. As illustrated, the control circuitry 30 includes signal interface circuitry 32 and logic circuitry 34. The signal interface circuitry 32 may include any suitable circuitry to receive signals from the differential pressure sensor 50 via one or more signal lines 36 and properly condition the signals (e.g., convert the signals to a format readable by the logic circuitry 34).

The logic circuitry 34 may include any suitable circuitry and processing equipment necessary to perform operations described herein. For example, the logic circuitry 34 may include any combination of dedicated processors, dedicated computers, embedded controllers, general purpose computers, programmable logic controllers, and the like. Accordingly, the logic circuitry 34 may be configured to perform operations described herein by standard programming means (e.g., executable software and/or firmware).

The signals generated by the inverse Venturi meter 60 may be any suitable combination of signals, such as electrical signals, optical signals, or pneumatic signals. Accordingly, the signal lines 36 may be any combination of signal bearing lines, such as electrically conductive lines, optical fibers, or pneumatic lines. Of course, an exact number and type of signal lines 36 will depend on a specific implementation of the inverse Venturi meter 60.

In operation, the inverse Venturi meter 60 is inserted into the production tubing 15 as shown in FIG. 2. The production tubing 15 along with the inverse Venturi meter 60 is lowered into the drilled out wellbore 20. The signal line(s) 36 may be connected to the differential pressure sensor 50 prior to or after inserting the inverse Venturi meter 60 into the wellbore 20. After flow F is introduced into the tubing string 15 from the formation 5, it flows upward into the inverse Venturi meter 60. The differential pressure sensor 50 measures the pressure difference from diameter A to the throat 61 in real time as the fluid F passes the throat 61.

The pressure difference from the throat 61 to diameter A is relayed to the surface 40 through the signal line(s) 36. The control circuitry 30 then converts the signal from the signal line(s) to meaningful flow rate data. To obtain the flow rate of the fluid F, the density of the fluid must be known. “Density” generally refers to volumetric density and is defined as a mass of a fluid contained within a volume divided by the volume. Density of the fluid F may be obtained by any known method. Suitable methods include, but are not limited to, measuring a density of the fluid F after it reaches the surface by known methods as well as measuring a density of the fluid downhole by, for example, including an absolute pressure sensor and an absolute temperature sensor along the inverse Venturi meter 60 and coupling the sensors to the pipe (formulating a density meter) and including suitable surface processing equipment as described in U.S. Pat. No. 6,945,095, entitled “Non-intrusive Multiphase Flow Meter,” filed on Jan. 21, 2003, which is herein incorporated by reference in its entirety.

The control circuitry 30 uses the density and the pressure differential to determine the flow rate of the fluid F. The equation utilized to determine the flow rate of the fluid F of a given density with A and B is the following:

$$Q = \sqrt{\frac{2}{ρ} \times DP \times \frac{π}{4} \times [ {D}_{B}^{2} - {D}_{A}^{2} ]} ,$$

where Q=flow rate, ρ=density of the fluid F, DP=minimum measurable pressure differential, D_{B}=the largest diameter or the expanded diameter of the inverse Venturi meter 60 (diameter B at the throat 61), and D_{A}=the smaller diameter of the inverse Venturi meter 60 upstream of the throat 61 (diameter A, or the nominal pipe size of the Venturi meter tubing). D_{A} may also be the smaller diameter C (or nominal pipe size) of the inverse Venturi meter 60 downstream of the throat 61, depending upon at which point on the inverse Venturi meter 60 the differential pressure sensor is located. When using the most preferable embodiment of the inverse Venturi meter 60 mentioned above, which is merely exemplary and not limiting, assuming no elevation of the inverse Venturi meter 60 and a fluid density of 0.85 g/cm³, the lowest measurable flow rate would be 0.08 feet/second for a differential pressure sensor 50 having a minimum differential pressure, or differential pressure resolution, of 0.001 pounds per square inch, differential (psid).

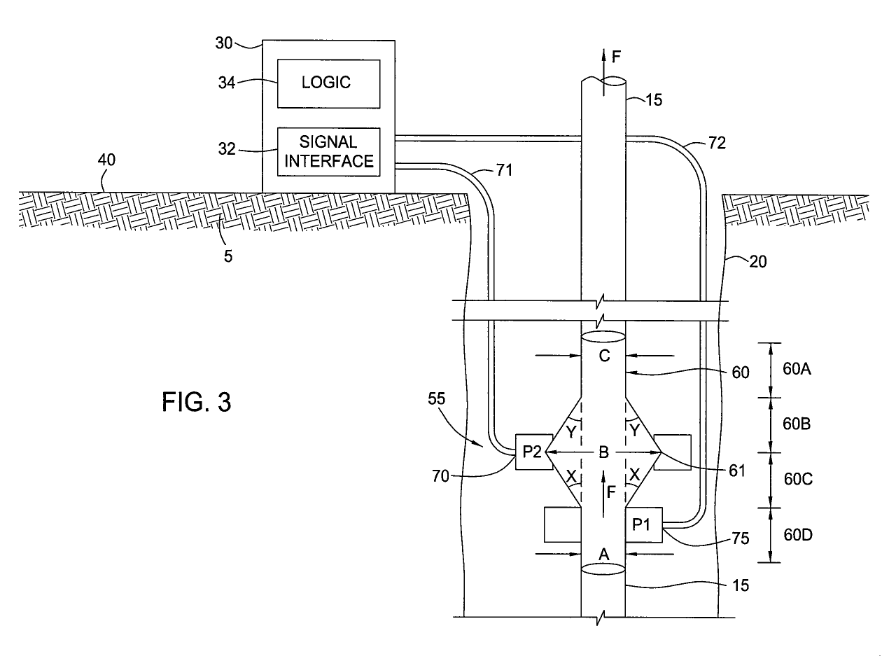

FIG. 3 shows a further alternate embodiment of the present invention. Like parts are labeled with like numbers to FIG. 2. Instead of a single differential pressure sensor 50, an upper absolute pressure sensor 70 is located at the throat 61, while a lower absolute pressure sensor 75 is located at portion 60D of the inverse Venturi meter having diameter A. The sensors 75 and 70 are coupled to the pipe. The upper and lower absolute pressure sensors 70 and 75 are high resolution sensors so that pressure may be detected at each location to a high precision so that a differential pressure results when the pressures are subtracted from one another at the surface. The upper pressure sensor 70 is connected by a signal line or cable 71 or optical waveguides to the control circuitry 30, and the lower pressure sensor 75 is likewise connected by a signal line or cable 72 or optical waveguides to the control circuitry 30. Alternatively, the sensors 70 and 75 may be connected to a single common signal line or cable (multiplexed).

In operation, each of the upper pressure sensor 70 and the lower pressure sensor 75 determine a pressure of the fluid F at locations near the throat 61 as well as near the portion 60D of diameter A. The upper pressure sensor 70 sends the pressure information from its location with a signal through signal line 71. The lower pressure sensor 75 sends the pressure information from its location with a signal through signal line 72. The control circuitry 30 then subtracts the two pressure measurements to determine the differential pressure and uses the density of the fluid with the determined differential pressure to calculate flow rate at a location using the same equation disclosed above in relation to FIG. 2.

Regardless of the particular arrangement, the differential pressure sensors 50 or absolute pressure sensors 70 and 75 may be any combination of suitable sensors with sufficient sensitivity to achieve the desired resolution (preferably 0.001 psid). As an example, the pressure sensors 50, 70, 75 may be any suitable type of ultra-sensitive strain sensors, quartz sensors, piezoelectric sensors, etc. Due to harsh operating conditions (e.g., elevated temperatures, pressures, mechanical shock, and vibration) that may exist downhole, however, accuracy and resolution of conventional electronic sensors may degrade over time.

Fiber optic sensors or optical sensors offer one alternative to conventional electronic sensors. Typically, fiber optic sensors have no downhole electronics or moving parts and, therefore, may be exposed to harsh downhole operating conditions without the typical loss of performance exhibited by electronic sensors. Additionally, fiber optic sensors are more sensitive than traditional sensors, which allows detection of the relatively small pressure differential produced by the inverse Venturi meter 60 of the present invention. Accordingly, for some embodiments, one or more of the sensors 50, 70, 75 utilized in the inverse Venturi meter 60 may be fiber optic sensors.

FIG. 4 shows an alternate embodiment of the present invention using a fiber optic sensor. Like parts in FIG. 4 are labeled with like numbers to FIG. 2. In this embodiment, the differential pressure sensor 50 is a fiber optic sensor, which satisfies the requirement of a high resolution differential pressure sensor 50. The signal line(s) 36 is a fiber optic cable or line, and the fiber optic or optical cable 36 is connected at one end to the fiber optic sensor 50 and at the other end to control circuitry 130, which includes optical signal processing equipment 135 and logic as well as a light source 133. The control circuitry 130 converts the signal relayed through the fiber optic line 36 to meaningful flow rate data and delivers signal light through the fiber optic line 36.

For some embodiments, the fiber optic sensors may utilize strain-sensitive Bragg gratings (not shown) formed in a core of one or more optical fibers or other wave guide material (not shown) connected to or in the signal line 36. A fiber optic sensor is utilized as the differential pressure sensor 50 and therefore becomes a fiber optic differential pressure sensor. Bragg grating-based sensors are suitable for use in very hostile and remote environments, such as found downhole in the wellbore 20.

As illustrated, to interface with fiber optic sensors, the control circuitry 130 includes a broadband light source 133, such as an edge emitting light emitting diode (EELED) or an Erbium ASE light source, and appropriate equipment for delivery of signal light to the Bragg gratings formed within the core of the optical fibers. Additionally, the control circuitry 130 includes appropriate optical signal processing equipment 135 for analyzing the return signals (reflected light) from the Bragg gratings and converting the return signals into data compatible with data produced by the logic circuitry 134.

The operation of the flow measurement system of FIG. 4 is the same as the operation of the flow measurement system of FIG. 2, except that the differential pressure sensor or fiber optic sensor 50 sends a fiber optic signal through the fiber optic cable 36 to the surface for processing with the optical signal processing equipment 135. The optical signal processing equipment 135 analyzes the return signals (reflected light) from the Bragg gratings and converts the return signals into signals compatible with the logic circuitry 134.

In a further alternate embodiment of the present invention, absolute pressure sensors 70 and 75 of FIG. 3 may be fiber optic or optical sensors, which send a signal through the fiber optic cable 36 of FIG. 4 to the control circuitry 130 for surface processing. In this embodiment, the control circuitry 130 may include a broadband light source 133, logic circuitry 134, and appropriate optical signal processing equipment 135, as described above in relation to FIG. 4. The pressure readings from fiber optic sensors 70 and 75 at the two locations are subtracted from one another and placed into the equation above stated to gain flow rate data. As in FIG. 3, the sensors 70 and 75 may alternatively be connected to a single common signal line or cable.

Whether fiber optic sensors are utilized as the differential pressure sensor 50 or the absolute pressure sensors 70 and 75, depending on a specific arrangement, the fiber optic sensors may be distributed on a common one of the fibers or distributed among multiple fibers. The fibers may be connected to other sensors (e.g., further downhole), terminated, or connected back to the control circuitry 130. Accordingly, while not shown, the inverse Venturi meter 60 and/or production tubing string 15 may also include any suitable combination of peripheral elements (e.g., fiber optic cable connectors, splitters, etc.) well known in the art for coupling the fibers. Further, the fibers may be encased in protective coatings, and may be deployed in fiber delivery equipment, as is also well known in the art.

In all of the above embodiments, multiple inverse Venturi meters 60 having diverging inner diameters at the throat 61 may be employed along the tubing string 15 to monitor flow rates at multiple locations within the wellbore 20. The inverse Venturi meter 60 of the above embodiments may be symmetric or asymmetric in shape across the throat 61, depending upon the divergence angles X and Y and the corresponding lengths of portions 60B and 60C.

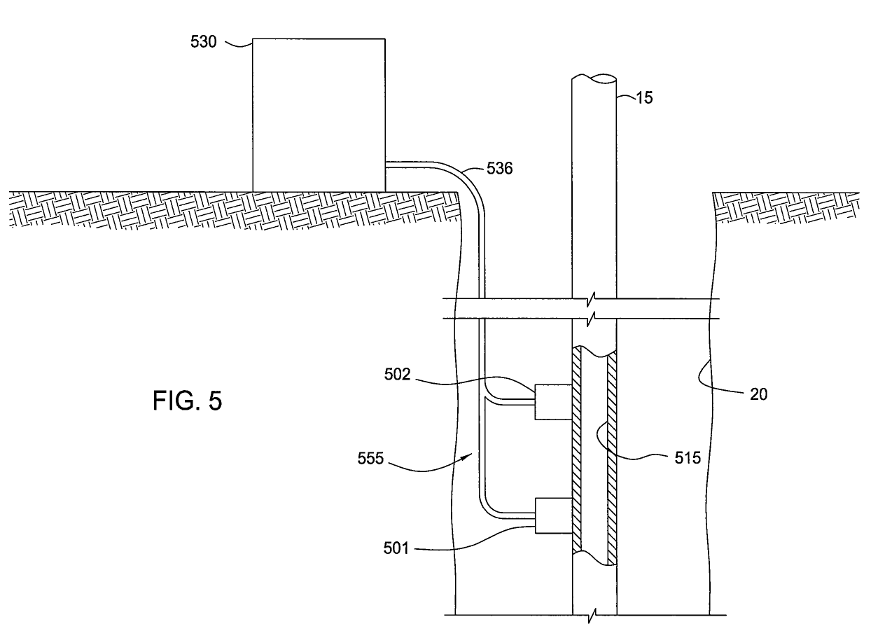

FIG. 5 illustrates a sectional view of a flow rate measurement system 555 with pressure differential determined along a section of tubing 15 where a diametrical cross-sectional interior area of the tubing 15 remains constant. The diametrical cross-sectional interior area remains constant as a result of no divergence or convergence in inner diameter and no increase or decrease in circumference of an inside surface of the tubing 15 across the section. As may be inherent with the tubing 15, circumferentially and longitudinally random profile variations of the inside surface of the tubing 15 creates a degree of roughness on the inside surface even though the diametrical cross-sectional interior area does not change across a length of the section. The differential pressure is thus taken at the section of the tubing 15 that lacks any added features to the tubing 15 intended to introduce changes in volume and pressure. Rather, difference in pressure as determined corresponds to unavoidable intrinsic pressure loss as the fluid moves though the section of the tubing 15 between locations of first and second pressure probes 501, 502.

In some embodiments, the pressure probes 501, 502 form part of a differential pressure sensor or define discrete absolute pressure sensors. Either sensor arrangement enables differential pressure sensing with the probes 501, 502. For some embodiments, ports through a wall of the tubing 15 at each of the probes 501, 502 facilitate transference of pressure from fluid inside the tubing 15 to the probes 501, 502. Further, the probes 501, 502 whether optical based, quartz sensors, or piezoelectric sensors enable differential pressure resolution of 0.001 psid or better (e.g., 0.0005 psid), as described above.

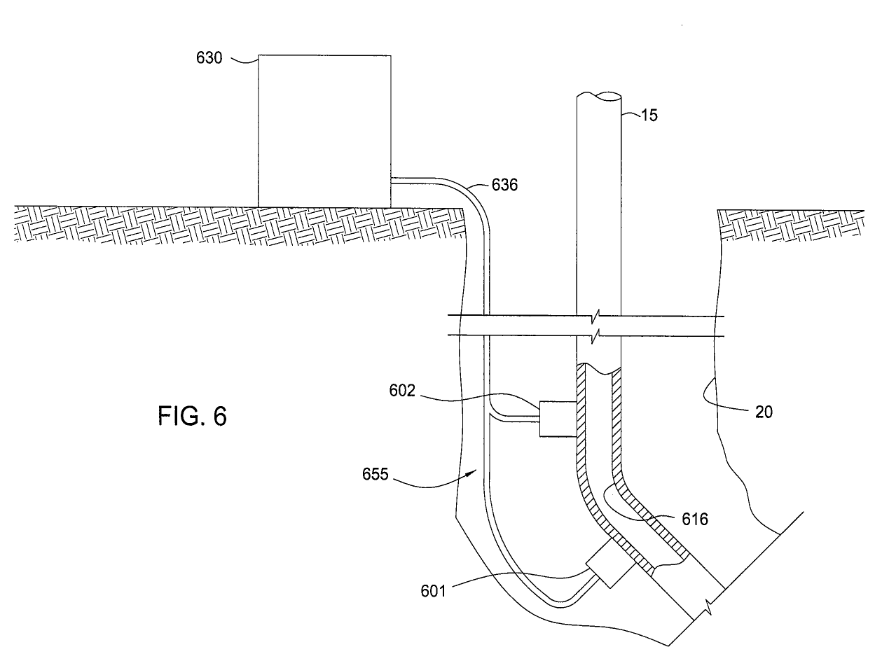

This sensitivity of pressure sensing performed with the probes 501, 502 enables reliable and accurate calculations to determine the flow rate of the fluid in the tubing 15 based on only head loss, which includes friction loss, any elevation head and any other losses such as flow direction changes that occur at bends in the tubing 15 (see, FIG. 6). For some embodiments, the section of the tubing 15 between the probes 501, 502 is straight and may be horizontal. The friction loss is head loss due to friction that the walls of the tubing 15 impose on the fluid therein and friction between adjacent fluid particles. The roughness of the tubing 15 thus contributes to how much of the friction loss is present such that the length of the section of tubing 15 between the probes 501, 502 may depend on the roughness of the tubing 15. Regardless of the roughness, the sensitivity of pressure sensing performed with the probes 501, 502 enables obtaining flow rate measurements when the length of the section of tubing 15 between the probes 501, 502 is less than 6.0 meters, 3.0 meters or 1.5 meters.

Control circuitry 530 couples to the probes 501, 502 via a wireless connection or a signal line 536. The control circuitry 530 calculates flow rate utilizing the following exemplary equations:

$$DP = f ( \frac{L}{D} ) ( \frac{ρ {V}^{2}}{2} ) and Q = V ( \frac{π {D}^{2}}{4} ) ,$$

where Q=the flow rate, ρ=density of the fluid, DP=the pressure differential measured with the probes 501, 502, D=the diameter of the tubing 15, L=the length of friction coefficient. Accounting for any elevation change can occur with a modified equation as follows:

$$DP = ρ g Δ z + f ( \frac{L}{D} ) ( \frac{ρ {V}^{2}}{2} ) ,$$

where g=the gravity acceleration constant and Δz=change in elevation of the tubing between the probes 501, 502. The density is a known or measured value whereas the length and diameter are given based on dimensional configurations of the system 555. The friction coefficient may be set by calibration or determined, utilizing known analytical techniques, based on the relative roughness of the tubing 15 and solving for the Reynolds number, which depends on viscosity of the fluid. Measuring of the pressure differential (DP) enables calculating the velocity (V) that can then be used to determine the flow rate (Q).

FIG. 6 shows a sectional view of a flow rate measurement system 655 with pressure differential determined along a section of tubing 15 that includes a bend 616. The bend introduces loss in addition to any friction loss as discussed with respect to FIG. 5. While changing direction of the flow, the bend 616 may not introduce any change to diametrical cross-sectional interior area of the tubing 15 between first and second probes 601, 602 used to sense pressure before and after the bend 616 or may introduce an increase in cross-sectional interior area of the tubing 15 at the bend 616 between first and second probes 601, 602.

In some embodiments, the probes 601, 602 may be disposed on each longitudinal side of the bend 616 and spaced less than 6.0 meters, 3.0 meters or 1.5 meters apart from one another. To facilitate proper readings, sufficient spacing between the probes 601, 602 enables reestablishing flow patterns prior to taking measurements such that about 10 to 30 times the diameter of the tubing 15 may separate the probes 601, 602. The probes 601, 602 form part of a differential pressure sensor or define discrete absolute pressure sensors and may be optical based, quartz sensors, or piezoelectric sensors that enable differential pressure resolution of 0.001 psid or better.

Pressure loss due to curvature in flow is determined according to the following formula:

$$DP = c ( \frac{ρ {V}^{2}}{2} )$$

where DP=the pressure differential measured with the probes 601, 602, ρ=density of the fluid, V=average velocity of the fluid, and c=a bend coefficient. The bend coefficient may be set by calibration or determined, utilizing known analytical techniques, based on inner diameter of the tubing 15, curvature radius and bend angle. Similar to FIG. 5, signals received from the probes 601, 602 via signal line 636 enable control circuitry 630 to calculate the velocity (V) and hence the flow rate.

In the embodiments employing fiber optic sensors, fiber optic pressure sensors described in U.S. Pat. No. 6,016,702, entitled “High Sensitivity Fiber Optic Pressure Sensor for Use in Harsh Environments” and issued to Maron on Jan. 25, 2000, which is herein incorporated by reference in its entirety, as well as any pressure sensors described in U.S. Pat. No. 5,892,860, entitled “Multi-Parameter Fiber Optic Sensor for Use in Harsh Environments” and issued to Maron et al. on Apr. 6, 1999, which is herein incorporated by reference in its entirety, may be utilized. The differential pressure sensor may include any of the embodiments described in U.S. Pat. No. 7,047,816, entitled “Optical Differential Pressure Transducer Utilizing a Bellows and Flexure System,” filed by Jones et al. on Mar. 21, 2003, which is herein incorporated by reference in its entirety. Any of the fiber optic pressure sensors described in the above-incorporated patents or patent applications is suitable for use with the present invention as the sensors placed along a flow measuring section of tubing to detect pressure differentials as described herein.

While the foregoing is directed to embodiments of the present invention, other and further embodiments of the invention may be devised without departing from the basic scope thereof, and the scope thereof is determined by the claims that follow.

What is claimed is:

1. A method of determining a flow rate of fluid flowing within a pipe, comprising:
providing the pipe, wherein a differential pressure is created in the fluid flowing through the pipe without introducing a constriction defining a discrete minimum interior cross-sectional area of the pipe in order to create the differential pressure;
measuring the differential pressure between two locations along the pipe, wherein the measuring achieves a differential pressure resolution of 0.001 pounds per square inch or better, differential; and
determining the flow rate for the fluid based on the differential pressure measured.

2. The method of claim 1, wherein the interior cross-sectional area of the pipe remains constant between the two locations.

3. The method of claim 2, wherein distance between the two locations is less than 6.0 meters.

4. The method of claim 1, wherein flow direction of the fluid in the pipe changes between the two locations.

5. The method of claim 1, wherein the measuring uses an optical based sensor.

6. The method of claim 1, wherein the measuring uses an electronic based sensor.

7. The method of claim 1, wherein the measuring uses a quartz pressure sensor.

8. The method of claim 1, wherein the differential pressure is measured using a differential pressure sensor.

9. The method of claim 1, wherein the differential pressure is measured using two absolute pressure sensors.

10. A method of determining a flow rate of fluid flowing within a pipe, comprising:
providing the pipe, wherein friction loss between the fluid and the pipe contributes to a differential pressure created in the fluid flowing through a section of the pipe with an interior cross-sectional area that remains substantially constant;
measuring the differential pressure between two locations along the section of the pipe, wherein the measuring achieves a differential pressure resolution of 0.001 pounds per square inch, differential or better; and
determining the flow rate for the fluid based on the differential pressure measured.

11. The method of claim 10, wherein distance between the two location is less than 6.0 meters.

12. The method of claim 10, wherein flow direction of the fluid in the pipe changes between the two locations.

13. The method of claim 10, wherein determining the flow rate for the fluid includes calculating the flow rate utilizing the differential pressure measured within an equation related to at least one of friction loss through the pipe and elevation head loss through the pipe.

14. The method of claim 10, wherein determining the flow rate for the fluid includes calculating the flow rate utilizing the differential pressure measured within an equation related to head loss through the pipe due to a change in direction of fluid flow through the pipe.

15. The method of claim 10, wherein the section of pipe is straight.

16. A system for measuring a flow rate of a fluid, comprising:
a pipe for containing the fluid, wherein a differential pressure is created when the fluid flows through a section of the pipe with an interior cross-sectional area that remains substantially constant;
pressure probes configured to measure the differential pressure between two locations along the section of the pipe, wherein the pressure probes have a differential pressure resolution of 0.001 pounds per square inch, differential or better; and
processing equipment for converting the differential pressure to flow rate data based on the differential pressure measured with the pressure probes.

17. The system of claim 16, wherein the pressure probes are separated by less than 6.0 meters.

18. The system of claim 17, wherein the section of the pipe between the pressure probes is straight.

19. The system of claim 16, wherein the pipe has a bend and a first of the pressure probes is disposed at a longitudinal opposite side of the bend from a second of the pressure probes.

20. The system of claim 16, wherein the processing equipment comprises logic configured to calculate the flow rate utilizing the differential pressure measured within an equation related to at least one of friction loss through the pipe and elevation head loss through the pipe.
